(19) United States
(12) Patent Application Publication
(10) Pub. No.: US 2008/0011244 A1
(43) Pub. Date: Jan. 17, 2008

(54) Sound producing pet toy

(75) Inventor: James W. Gick, Laguna Niguel, CA (US)

Correspondence Address: CROCKETT & CROCKETT, 24012 CALLE DE LA PLATA, SUITE 400, LAGUNA HILLS, CA, 92653, US

(73) Assignee: Pet Qwerks, Inc.

(21) Appl. No.: 11/827,177

(22) Filed: Jul. 10, 2007

Related U.S. Application Data
(63) Continuation of application No. 10/877,917, filed on Jun. 25, 2004.
(60) Provisional application No. 60/482,884, filed on Jun. 26, 2003.

(51) Int. Cl. A01K 29/00; A63H 5/00

(52) U.S. Cl. 119/707

(57) ABSTRACT

A pet toy that produces sounds or lights when a sensor disposed in the pet toy detects motion or vibration. The sensor is highly sensitive such that the toy will produce sound or lights when the sensor senses that the toy housing has moved, even over a very short distance. The highly sensitive pet toy reacts more like a live creature than prior art pet toys, thereby creating a more interesting toy for pets.

This application claims priority to U.S. Provisional Application 60/482,884, filed Jun. 26, 2003.

### FIELD OF THE INVENTION

The inventions described below relate to the field of pet toys.

### BACKGROUND OF THE INVENTION

Sound and light producing toys triggered by motion are known. Shishido, Sound Emitting Ball, U.S. Pat. NO. 4,595,200 (Jun. 17, 1986) shows a ball that emits a sound upon a significant impact. Rumsey, Sound Producing Ball, U.S. Pat. No. 4,662,260 (May 5, 1987) shows a similar ball. Gentile, Game Ball, U.S. Pat. No. 5,924,942 (Jul. 20, 1999) shows a ball having an internal LED that activates when the ball experiences an impact. Newbold et al., Motion Responsive Musical Toy, U.S. Pat. No. 5,221,225 (Jun. 22, 1993) shows a child's toy that produces music when it. senses that it is in motion. Udelle, et al., Animal Attracting Sound Producing Ball, U.S. Pat. No. 5,575,240 (Nov. 19, 1996) shows a ball activated by pressure sensitive switches triggered by the motion of the ball.

These devices incorporate motion sensors that can trigger different sounds or lights. Different designs of motion sensors may include a metallic ball that establishes a connection between two or more contacts. In order for the metallic ball to make a connection, the contacts have to be raised above the surface upon which the ball rolls. The movement of the ball and accordingly the sensitivity of the motion detector are thus impeded. Furthermore, the elevated contacts result in a tendency of the ball to ride along or between contacts rather than over the upper surfaces thereof, thereby preventing proper triggering of sounds. Other motion switch designs may use springs or wires attached to a ball to dampen switching, which prohibits a high switching frequency. A high switching frequency can trigger sounds or lights too often, not allowing initial sounds or lights to complete a predetermined sequence before the toy is triggered again.

Because prior art toys are not sensitive enough, animals tend to loose interest in prior art toys. An animal is more likely to play with a toy that responds in a more life-like manner when the animal interacts with the toy.

### SUMMARY

The methods and devices described below provide for a highly sensitive sound or light producing toy. The toy is sufficiently sensitive that it will activate when a sensor disposed inside the toy senses a vibration or a slight motion of the toy. The toy produces one or more sounds or lights for a predetermined length of time upon activation. The toy will not activate again until a predetermined time has elapsed, thereby preventing sound or light sequences from overlapping each other.

### BRIEF DESCRIPTION OF THE DRAWINGS

FIG. 1 shows a sound-producing toy.

FIG. 2 is a side exploded view of the sound-producing toy of FIG. 1.

FIG. 3 shows the toy of FIG. 1 as assembled.

FIG. 4 is another side exploded view of a sound-producing toy.

FIG. 5 shows the toy of FIG. 4 as assembled.

FIG. 6 shows a circuit board for use with a sound-producing toy.

FIG. 7 shows a sensor mounted on a circuit board.

FIG. 8 is a schematic of a control circuit for controlling a sound-producing toy.

FIG. 9 shows a light-producing toy.

FIG. 10 shows the interior of the light-producing toy of FIG. 9.

FIG. 11 shows an LED arrangement for the light-producing toy of FIG. 9.

FIG. 12 is a schematic of a control circuit for controlling a light-producing toy.

### DETAILED DESCRIPTION OF THE INVENTION

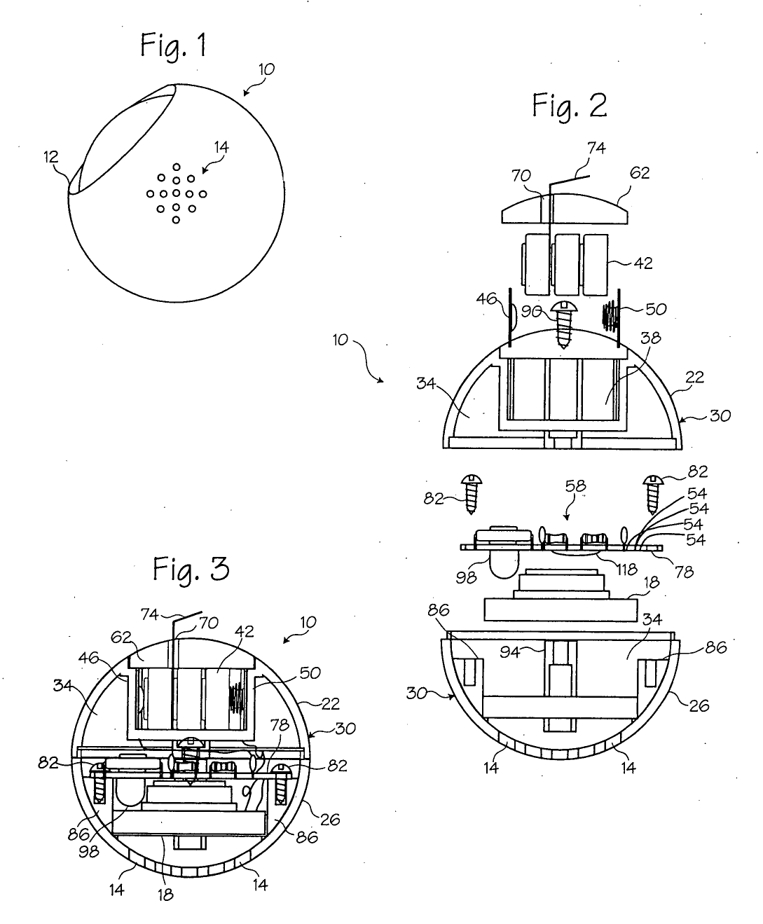

FIG. 1 shows a pet toy 10 in the shape of a ball. If the toy moves or is subject to a sufficient vibration, a sensor detects the movement or vibration and then triggers a speaker to emit sound or triggers a light source to emit light. The toy is extremely sensitive and can respond to the slight movement (such as that caused by a gentle push or rocking) or vibration (such as that caused by striking a surface upon which the toy rests or by an animal walking near the toy). Because the toy is extremely sensitive, the toy generates the illusion that an animal is within the ball or that the ball is alive. Thus, the toy will more easily attract a real animal and increase the likelihood that the real animal will play with the toy.

Preferably, the toy is sufficiently sensitive that the toy will emit a sound or light if the toy is rotated less than a quarter turn along at least one axis of the toy's housing. In addition, the average distance a spherical toy rolls before emitting a sound or light is preferably between about 0.5 inches and about 3 inches. The spherical toy is sufficiently sensitive that it may emit a sound or light if rolled less than about 0.1 to about 0.5 inches.

Because the pet toy is so sensitive, without a control circuit the toy will be triggered multiple times while in normal use. Rapid multiple triggers cause the toy to emit a stuttering sound sequence or light sequence instead of complete sound or light sequences. Thus, the toy preferably produces a predetermined sound sequence or light sequence during a blanking period (for a predetermined length of time) and does not produce a second sound sequence or light sequence until the blanking period has ended. A sound sequence is a word, phrase, single sound effect, dog barking, cat meowing, person speaking in a tone of voice believed to be pleasing to animals, a sequence of sound effects or any other sound that the toy emits during a predetermined time upon being triggered. A light sequence is a single light source activated during a predetermined time period, a single light source activated multiple times during a predetermined time period, multiple light sources activated during a predetermined time period or multiple light sources activated in sequence during a predetermined time period, differently colored light sources activated in a sequence or together during a predetermined time period or any other sequence of lights emitted by the toy during a predetermined time period. A light sequence also includes varying the intensity of light emitted by one or more light sources, either together or separately. A light sequence also includes varying the intensity and color of light emitted by one or more light sources to produce a plurality of colors, scintillating colors or a rainbow of colors.

The toy has a housing which may be provided in a variety of shapes, including a ball, a square, a football shape, an animal face, or other shape, though preferably the toy should have the ability to roll. The outer layer or skin 12 may be made of plastic, rubber or any durable or pliable material that resists damage from being chewed by an animal. The outer layer 12 may also be made of a soft material ideal for children to grab and hold. The toy 10 may include various holes 14 that allow sound to pass from a speaker 18 located inside the toy 10 to the outside environment. The toy 10 may be manufactured in various different sizes and the housing may be constructed using separately manufactured sections that are glued together.

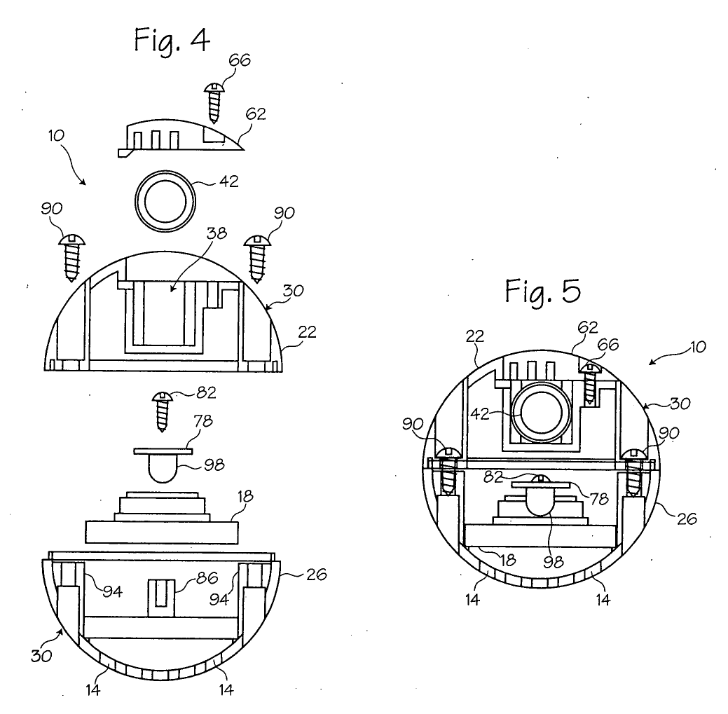

With reference to FIGS. 2 through 5, a first shell half 22 and a second shell half 26 are joined to establish an outer surface 30 of the toy 10. (However, molding the battery compartment as one piece eliminates a glued seam or fasteners that could interfere with light transmission.) The outer surface 30 of the two shell halves 22, 26 may be covered by the outer skin 12, as shown in FIG. 1. The assembled shell halves 22, 26 define a cavity 34 within, and may be easily formed with conventional injection molding techniques. FIGS. 3 and 5 illustrate assembled side views of the toy 10. The internal components are positioned to maximize the amount of space found inside the cavity 34.

The first shell half 22 has a battery receptacle 38 to hold at least one battery 42. The battery or batteries preferably contain enough power for the toy to emit 12,000 or more sound sequences or light sequences. The battery power source 42 delivers electricity through a positive battery conducting pad 46 and a negative conducing spring 50. (Other power sources may also be provided with the toy.) The battery conductors 46, 50 are connected to various wires 54 to supply a control circuit 58 with the required electrical power. A battery cover 62 with a 10 curved outer shape encloses the batteries 42 inside the battery receptacle 38 and allows the ball to have a circular shape when the battery cover 62 is properly installed. The battery cover 62 is fastened to the first shell half 22 through a battery cover mounting screw 66. The battery cover 62 also includes a slit 70 that allows a strip 74 of non-conducting material to be inserted through a battery connection. When in place, the strip disables electrical power to the control circuit 58. The strip 74 is inserted to preserve battery life during shipping or to turn off the toy.

The control circuit 58 is located on a circuit board 78 that is mounted to the second shell half 26 through circuit board mounting screws 82 to bosses 86 integrally formed in the second shell half 26. The speaker 18 is mounted on the second shell half 26 in between the circuit board 78 and the second shell half boss 86. The speaker is positioned near holes 14 located on the outer surface of the toy to increase the perceived volume of sounds emitted by the speaker.

The two shell halves 22, 26 are held together to form a ball shape through shell fastening screws 90 that screw into corresponding bosses 94 integrally formed in the second shell half 26. The two shell halves 22, 26 may also be held together to form a ball shape with a glue and/or and epoxy applied to the outer edges of each shell half or by other suitable means for fixing the shell halves together.

If a glue is used to seal the toy, the toy and the blister package in which the toy is shipped are provided with ventilation holes to ventilate the toy. (The speaker holes in the toy may serve as the ventilation holes.) Certain glues emit vapors that corrode or otherwise degrade the sensitivity of the motion and vibration sensor disposed within the toy. Ventilating the toy and the package in which the toy is shipped allows the vapors to escape and alleviates this problem.

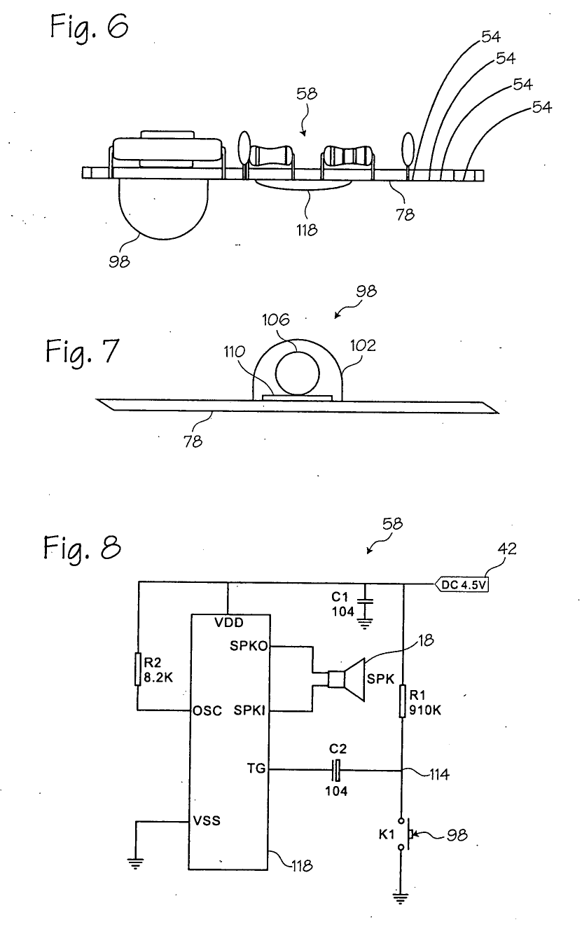

FIG. 6 illustrates a magnified view of the circuit board 78. The sensor 98 is electrically connected to the control circuit 58, which includes an integrated circuit chip 118. Wires 54 electrically connect the control circuit to the batteries and to the speaker or light sources. The sensor 98 is a means for sensing motion (translation, rotation or vibration) of the housing.

FIG. 7 shows a sensor 98 in greater detail. The sensor 90 is a metallic cover 102 having an approximately hemispherical shape, a metallic ball or BB 106 and a metallic pad 110. The ball rolls on the pad as the toy housing moves or vibrates. Thus, the ball frequently touches both the pad and the cover, thereby establishing an electrical contact that triggers the toy to emit sounds or lights (as controlled by a control circuit). The metallic ball 106, the metallic cover 102 and the metallic pad 110 may be made of brass. However, the ball, cover and pad may also be made from other metals or other conducting materials.

The pad 110 is positioned relative to the cover such that the pad does not contact the cover 102. The pad 110 is further positioned close enough to the cover to allow the ball 106 to establish an electrical connection between the cover 102 and the pad 110. At a minimum, the ball is disposed slightly inside the cover and the ball has a diameter sufficient to make contact between the cover and the pad. Preferably, the pad is disposed such that the center of the pad is located at about the center of the hemispherical cover.

The diameter of the ball is a significant factor in the sensitivity of the sensor. If the diameter of the ball is large relative to the radius of the cover, the ball is more likely to establish electrical contact between the pad and the cover. Because the sensor should be extremely sensitive, the diameter of the metallic ball 106 is between about the radius of the metallic cover 102 to slightly less than twice the radius of the metallic cover 102 (almost touching).

The flatness of the pad is also a factor in the sensitivity of the sensor. If the pad is flat, as opposed to dimpled or grooved, then the ball more easily rolls across the surface of the pad. Thus, the ball is more likely to establish electrical contact between the cover and the pad.

To further increase the sensitivity of the toy, additional sensors may be added to the toy. Preferably, each sensor has a different orientation with respect to gravity (the pad of each sensor makes a different angle with respect to the downward force of gravity when the housing is held in a predetermined orientation). In this case, the toy will emit sound or light if any one of the balls makes contact between a respective cover and pad. To prevent multiple sound sequences or light sequences from overlapping each other, the control circuit may be further adapted to create a blanking period during which the toy will ignore additional triggers from any sensor. (In other words, the toy will emit only one sound sequence or light sequence during the blanking period.)

Other type of motion or vibration sensors may be used with the toy, such as sensitive accelerometers. However, the motion sensor should be extremely sensitive such that the toy will be triggered to emit sound or light if the toy housing is rotated by less than a quarter turn.

FIG. 8 is a schematic of a control circuit 58 adapted to establish a blanking period. When the sensor 98 detects a motion or a vibration, a switch is opened and the voltage at a node 114 begins to rise until it reaches a steady state voltage. A resistor R1 determines the rate at which the steady state voltage is reached. During the time that the voltage at the node 114 is rising, a capacitor voltage across a capacitor C2 is decreasing towards zero due to a rising voltage at TG. Both voltages on either side of the capacitor C2 are approaching the battery voltage so the capacitor voltage across C2 approaches zero volts. At this state, when the switch has been opened for a predetermined amount of time, the voltage at TG and the node voltage are both equal to the battery voltage and the voltage across the capacitor C2 equals zero.

When the switch is closed, the node voltage instantaneously goes to 0 volts. The TG voltage also goes to zero because the voltage across the capacitor C2 cannot change instantaneously. When the TG voltage goes to 0 volts, a chip or integrated circuit (IC) 118 controlling the sound is triggered to deliver the sound through the speaker 18 for a predetermined amount of time. The voltage across the capacitor C2 starts to increase because of the growing voltage between TG and the node because the node is grounded and the voltage at TG is being charged by the battery. The capacitor C2 voltage reaches a steady state voltage until the switch is opened again. When the switch opens, the battery voltage is applied through resistor R1 to the capacitor C2. The voltage across the capacitor again decreases towards 0 volts and the voltage at the node 114 increases again. The rate at which the capacitor voltage returns to zero after the switch is opened is determined by the value of the resistor R1.

When the sensor detects a motion or vibration, the sensor causes the switch to trigger the IC 118. The IC 118 emits successive sounds only after a prior sound has finished and the switch is opened and closed again. Therefore, when the toy 10 is stationary and detects no motions or vibrations, no sound is emitted even if the switch is closed. Sounds will only emit from the toy once the switch is opened again after being closed.

The control circuit 58 and the IC 118 require a small or negligible amount of power after a sound has been activated, thereby conserving power and extending battery life. The sensor 98 may also be thought of as a starting device; thus, for example a sound will only be triggered after a sound activation is complete and the switch is opened and closed again. This combination of sensor design and IC architecture provides an easily triggered, dependable, and enjoyable toy with long battery life.

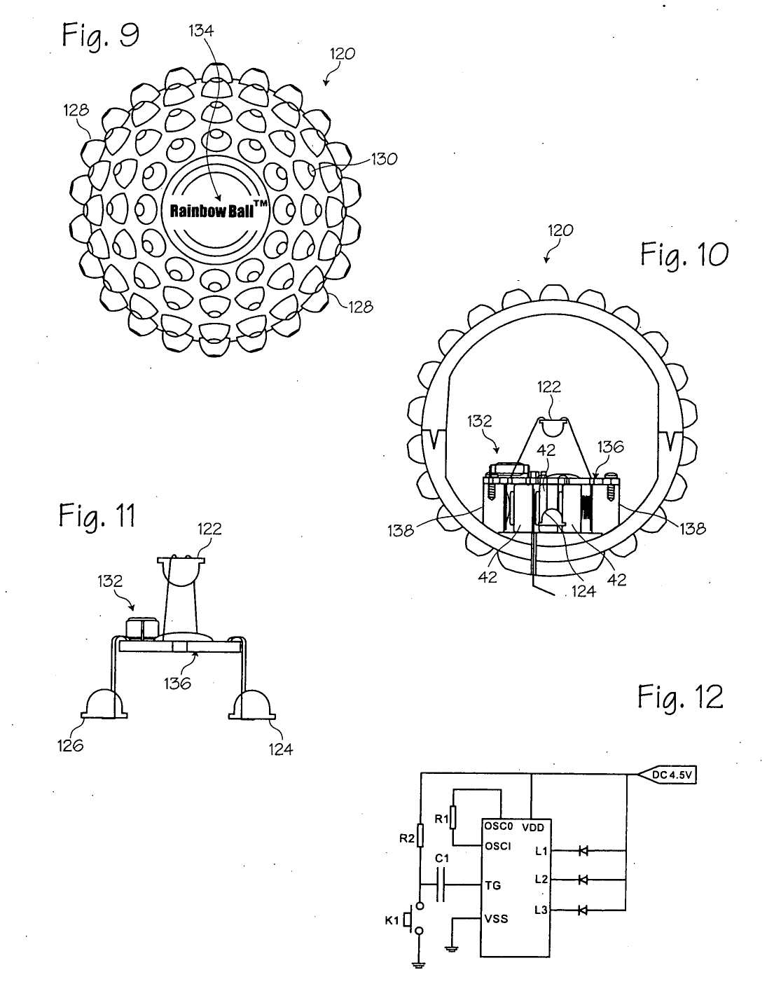

FIGS. 9 and 10 show a light-producing toy 120. Preferably, the light sources are one or more light emitting diodes (LEDs) 122, 124 and 126 that produce light when the toy is triggered, though other lamps or light sources may be used. Each LED produces a different color of light whose intensity varies over time. Thus, the toy emits an ever-changing or scintillating rainbow of colors. (One or more multi-wavelength LEDs may also be used to emit a rainbow of colors.) Each light may be programmed to fade or brighten in intensity over time to emulate light displays such as the Aurora Borealis.

To vary the quality of the light, bumps 128 may be distributed over the surface of the ball. Each bump is transparent, translucent, is a lens or color filter or each bump mounts a lens or color filter. The bumps may be opaque and the surface of the ball transparent or translucent, or both the bumps and the surface of the ball may be transparent or translucent. Each bump is has a hemispherical shape with a flattened portion 130 facing outwardly from the housing. However, the bumps may have other shapes, such as spikes, cubes, faces, letters, numbers, characters or other shapes or objects.

One or more of the bumps may contain an LED or other light source. The bumps (with or without LEDs) may be arranged to form shapes on the surface of the toy such as, but not limited to a smiley face, a character or other object. Shapes may also be displayed using multiple bumps or light sources distributed relatively evenly over the surface of the toy. In this case, a processor or control circuit is provided to activate the light sources in a predetermined pattern or sequence such that the toy displays faces, characters or other objects over the surface of the toy. Thus, the toy may emit light in a variety of colors, textures, sequences and patterns.

Preferably, an LED or light source does not activate multiple times during a blanking period. Thus, an LED does not emit a second light sequence until the blanking period has expired, even if the toy is triggered multiple times during the blanking period.

The toy may be provided with one or more marks 134 on a portion of the surface of the toy in order to increase the market appeal of the toy or to identify the toy. A marked toy may be displayed near other pet toys and marketed as having the ability to emulate a live animal. The toy may also be marketed as a children's toy.

FIG. 11 shows an LED arrangement for the light-producing toy of FIG. 9. LED 122 is a green LED, LED 124 is a red LED and LED 126 is a blue LED. The green LED is mounted such that it is about in the center of the ball, with the blue and red LEDs mounted such that they are near the inner surface of the ball but separated by a distance slightly larger than the. A circuit board 136 is mounted to the inside surface of the toy via mountings 138. A control circuit 132 capable of controlling the three LEDs is disposed on the circuit board 136. The battery compartment, control circuit and any light sources provided inside the toy are disposed in one end of the housing in order to avoid blocking the projection of light to all areas of a translucent or transparent toy.

FIG. 12 is a schematic of a control circuit for controlling a-light-producing toy. The circuit is similar to that shown in FIG. 8 in that the circuit establishes a blanking period during which the LEDs will not begin a new light sequence if the toy is triggered multiple times during the blanking period.

The control circuit is powered by a battery, which preferably provides 4.5V. L1 is the red LED, L2 is the blue LED and L3 is the green LED. R1 is a resistor, preferably having a value of 47KΩ, which controls the length of the blanking period. R2 is a resistor, preferably having a value of 910KΩ that moderates the sensitivity of the switch K1. C1 is a capacitor, preferably having a value of 104 μF, that controls the input current for the motion switch.

A pet toy may be described as a spherical body, the spherical body comprising a first shell half, a second shell half, a battery, a speaker, and a circuit board, the shell halves joined to form an exterior surface for manual manipulation, the halves forming a cavity, the circuit board positioned inside the cavity and electrically connected to both the battery and the speaker, the circuit board comprising electrical components including an integrated circuit and a sensor operably attached to a switch, the sensor comprising a metallic shell, a metallic ball and a metallic pad, the shell being positioned over the metallic pad and enclosing the ball, the switch triggering the integrated circuit when the sensor forms an electrical connection between the metallic shell and metallic pad when the metallic ball comes in contact simultaneously with the metallic shell and metallic pad,.the integrated circuit activating a sound when the switch is closed and only activating another sound when the switch is again opened and closed, and no other sound is being activated.

Another pet toy comprises a motion sensitive switch comprising a metallic shell, a metallic ball, and a metallic pad,.the metallic shell-being positioned over the metallic pad and enclosing the metallic ball, the motion sensitive switch communicating with a battery, and a circuit board, the circuit board connected to both the battery and a device, the circuit board comprising electrical components including an integrated circuit, the motion sensitive switch triggering the integrated circuit when the motion sensitive switch forms an electrical connection between the metallic shell and metallic pad when the metallic ball comes in contact simultaneously with the metallic shell and metallic pad, the integrated circuit activating the device when the motion sensitive switch is closed.

Other devices incorporating the sensor 98, with and without the accompanying circuit 58, are also possible including children's toys, flashlights, sporting goods products and security and alarm systems. Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

1. A pet toy comprising:
a housing;
a speaker disposed within the housing;
a means for sensing motion of the housing, said means disposed within the housing;
a power source disposed within the housing;
a control circuit electrically connected to the power 'source, the means for sensing motion and to the speaker, said control circuit adapted to cause the speaker to emit a predetermined sound sequence when the means for sensing motion is triggered;
wherein the average distance the housing rolls before the means for sensing motion is triggered is between about 0.5 inches and about 3.0 inches.

2. The pet toy of claim 1 wherein the control circuit is further adapted to establish a blanking period.

3. (canceled)

4. (canceled)

5. A pet toy comprising:
a housing;
a speaker disposed within the housing;
a means for sensing motion of the housing, said means disposed within the housing;
a power source disposed within the housing;
a control circuit electrically connected to the power source, the means for sensing motion and to the speaker, said control circuit adapted to cause the speaker to emit a predetermined sound sequence when the means for sensing motion is triggered;
wherein means for sensing motion is triggered when the housing is rotated less than one-quarter turn about at least one axis of the housing.

6. The pet toy of claim 5 wherein the control circuit is further adapted to establish a blanking period.

7. (canceled)

8. (canceled)

9. A pet toy comprising:
a housing;
a speaker disposed within the housing;
a control circuit disposed within the housing and operably connected to the speaker, said control circuit adapted to control the speaker;
a sensor operably disposed within the housing and operably connected to the control circuit, said sensor capable of detecting a stimulus selected from the group consisting of translation of the housing, rotation of the housing and vibration of the housing, wherein the control circuit is further adapted to cause the speaker to emit a predetermined sound sequence when the sensor senses a stimulus;
a power source operably connected to the speaker, the sensor and the control circuit;
wherein the sensor further comprises:
a cover comprising a conducting material, said cover having a shape approximating a hollow hemisphere;
a flat pad comprising a conducting material;
a ball comprising a conducting material, said ball disposed between the pad and the cover and further disposed at least partially inside the cover;
wherein the diameter of the ball is sufficient to contact both a portion of the surface of the pad and a portion of the inner surface of the cover when the ball touches at least one point on the surface of the pad.

10. The pet toy of claim 9 wherein the cover has a radius and wherein the diameter of the ball is between about the radius of the cover and less than twice the radius of the cover.
